(19) United States
(12) Patent Application Publication
(10) Pub. No.: US 2025/0368076 A1
(43) Pub. Date: Dec. 4, 2025

(54) SYSTEM AND METHOD FOR AUTOMATED CHARGING TO OPTIMIZE BATTERY LIFE ON ELECTRIFIED VEHICLE

(71) Applicant: FCA US LLC, Auburn Hills, MI (US)

(72) Inventors: Victor F Raymond, III, Lake Orion, MI (US); Samuel Phelps, Royal Oak, MI (US); Daniel Studt, Northville, MI (US); Katherine Morrow-Abraham, East China, MI (US)

(21) Appl. No.: 18/677,011

(22) Filed: May 29, 2024

(51) Int. Cl. B60L 53/62

(52) U.S. Cl. CPC B60L 53/62; B60L 2240/80; B60L 2260/54

(57) ABSTRACT

An automated charging system that charges a high voltage battery system of an electrified vehicle includes a human machine interface (HMI) and a controller. The HMI receives inputs from a user indicative of desired charge parameters related to the high voltage battery system. The controller is configured to: receive the desired charge parameters including a desired state of charge of the high voltage battery at charge completion, and a desired charge end time; determine whether a charge optimization rate has been selected; determine a minimum current required to reach the desired state of charge by the desired charge end time based on the charge optimization rate being selected; and charge the high voltage battery system at the minimum current required.

### FIELD

The present application generally relates to electrified vehicles and, more particularly, to a system and method that implements automated charging strategies to optimize battery life on an electrified vehicle.

### BACKGROUND

An electrified vehicle (hybrid electric, plug-in hybrid electric, range-extended electric, battery electric, etc.) includes at least one battery system and at least one electric motor. Typically, the electrified vehicle could include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. Electrified vehicles require an electrical charging cord, such as a Type 2/Level 2 portable charger, that electrically couples between a power source and the vehicle battery. Typically, when the electrified vehicle is plugged in for recharging, the electrified vehicle allows as much current from the power source as possible to promote rapid charging. In some examples, users can schedule charging to take advantage of off-peak electricity rates. However, even with scheduling, the electrified vehicle will still charge at a highest rate possible. Accordingly, while such electrified vehicle charging connections do work for their intended purpose, there exists an opportunity for improvement in the relevant art.

### SUMMARY

According to one example aspect of the invention, an automated charging system that charges a high voltage battery system of an electrified vehicle includes a human machine interface (HMI) and a controller. The HMI receives inputs from a user indicative of desired charge parameters related to the high voltage battery system. The controller is configured to: receive the desired charge parameters including a desired state of charge of the high voltage battery at charge completion, and a desired charge end time; determine whether a charge optimization rate has been selected; determine a minimum current required to reach the desired state of charge by the desired charge end time based on the charge optimization rate being selected; and charge the high voltage battery system at the minimum current required.

In some implementations, the controller is further configured to determine whether the electrified vehicle is plugged into an external charging system.

In some implementations, the controller is further configured to determine whether a delay of charge start time has been requested; and charge the high voltage battery system at a conventional high rate based on the delay not being requested.

In some implementations, the controller is further configured to receive the desired charge parameters including a charge start time.

In additional features, determining whether a charge optimization rate has been selected includes determining whether the charge optimization rate has been selected at the HMI.

In additional features, the controller is further configured to determine the minimum current based on a capacity of the high voltage battery system.

In additional features, the controller is further configured to determine the minimum current based on a capacity of the external charging system.

A method that implements an automated charging strategy using an automated charging system of an electrified vehicle is provided. The method includes: receiving, at a controller, desired charge parameters including a desired state of charge of the high voltage battery at charge completion, and a desired charge end time; determining, at the controller, whether a charge optimization rate has been selected; determining, at the controller, a minimum current required to reach the desired state of charge by the desired charge end time based on the charge optimization rate being selected; and charging the high voltage battery system at the minimum current required.

In additional features, the method includes determining, at the controller, whether the electrified vehicle is plugged into an external charging system.

In additional features, the method includes determining, at the controller, whether a delay of charge start time has been requested; and charging the high voltage battery system at a conventional high rate based on the delay not being requested.

In additional features, the method includes receiving, at the controller, the desired charge parameters including a charge start time.

In additional features, the method includes determining whether a charge optimization rate has been selected includes determining whether the charge optimization rate has been selected at the HMI.

In additional features, the method includes determining, at the controller, the minimum current based on a capacity of the high voltage battery system.

In other features, the method includes determining, at the controller, the minimum current based on a capacity of the external charging system.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle that implements an automated charging system that optimizes the life of the high voltage battery according to various principles of the present application; and

FIG. 2 is a logic flow illustration of a control method that implements an automated charging strategy using the automated charging system of FIG. 1 according to one example of the present disclosure.

### DESCRIPTION

As discussed above, electrified vehicles require an electrical charging cord, such as a Type 2/Level 2 portable charger, that electrically couples between a power source and the vehicle battery for charging. Typically, when the electrified vehicle is plugged in for recharging, the electrified vehicle allows as much current from the power source as possible to promote rapid charging. In some examples, users can schedule charging to take advantage of off-peak electricity rates. However, even with scheduling, the electrified vehicle will still charge at a highest rate possible. In examples, delivering high current during recharging can have a negative effect on battery life. In general, a reduced charging rate can promote longer life of the high voltage battery.

The present disclosure provides an automated charging system that implements an automated charging strategy to optimize the life of the high voltage battery. In particular, the automated charging strategy allows the user to utilize the maximum amount of electric “off-peak” (low rate) hours while also balancing the speed of charging. As such, a user will be able to achieve a maximum charge during a desired charge window while minimizing the current to the high voltage battery thereby prolonging battery longevity.

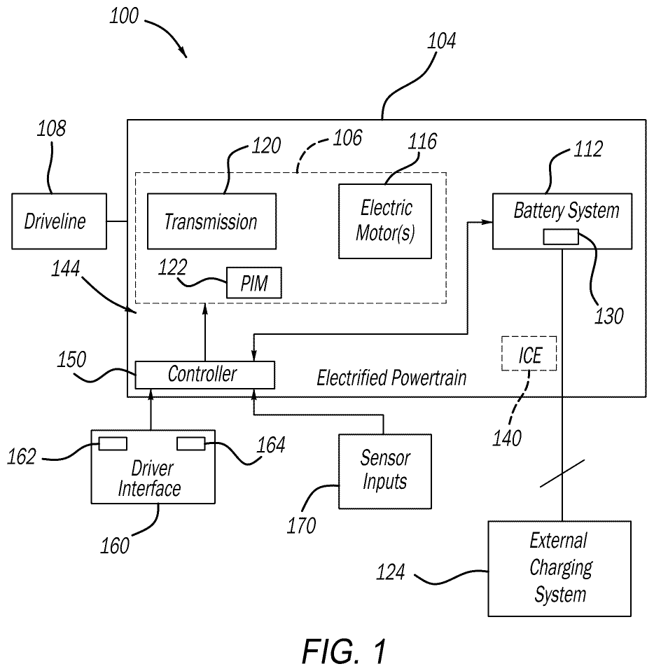

Referring now to FIG. 1, a functional block diagram of an example hybrid electric vehicle 100 (also referred to herein as “vehicle 100”) according to the principles of the present application is illustrated. The vehicle 100 includes an electrified powertrain 104 having an electrified drive module (EDM) 106 configured to generate and transfer drive torque to a driveline 108 for vehicle propulsion. The EDM 106 generally includes one or more electric drive units or motors 116 (e.g., electric traction motors), an electric drive gearbox assembly or transmission 120, and power electronics including a power inverter module (PIM) 122. In some examples, the exemplary powertrain 104 includes multiple electric motors such as a first electric motor configured to deliver drive torque to a front drive axle and a second electric motor configured to deliver drive torque to a rear drive axle.

The electric motor(s) 116 are connected via the PIM 122 to a high voltage battery system 112 for powering the electric motor(s) 116. The battery system 112 is selectively connectable (e.g., by the driver) to an external charging system 124 (also referred to herein as “charger 124”) for charging of the battery system 112. The battery system 112 includes at least one battery pack assembly 130. The electrified powertrain 104 can also be configured as a hybrid powertrain that additionally includes an internal combustion engine (ICE) 140. In such a configuration, the electric motor(s) 116 and the ICE 140 cooperate to provide drive torque to the driveline 108.

A vehicle control system, or automated charging system 144 includes a controller 150 that can provide charging instructions to the battery system 112 and therefore the external charging system 124 based on signals received from a driver interface 160. In examples, the driver interface 160 can include a drive input device, e.g., an accelerator pedal 162, for providing a driver input, e.g., a torque request, to the controller 150 and ultimately the EDM 106.

The driver interface 160 can further include a human machine interface (HMI) 164 for displaying driver information and receiving driver requests related to desired charging parameters for charging the battery system 112 such as charge rate and schedule. The HMI 164 can include any interface that receives an input from the user or driver indicative of a charging parameter of the battery system 112 such as, but not limited to, a charge rate and schedule. In some examples, the HMI can be arranged on a dashboard and/or steering wheel of the electrified vehicle 100.

While the vehicle control system 144 is shown as a single controller 150, it will be appreciated that more controllers and/or modules, such as a supervisory electrified vehicle control module, a battery control module, a motor control module and a chassis stability module, can be utilized to control various vehicle components of the electrified vehicle 100. In this regard, various controllers and modules are configured to communicate with each other, utilizing different sensor inputs 170 and calculated parameters as disclosed herein for controlling the charge rate of the battery system 112 using the external charging system 124.

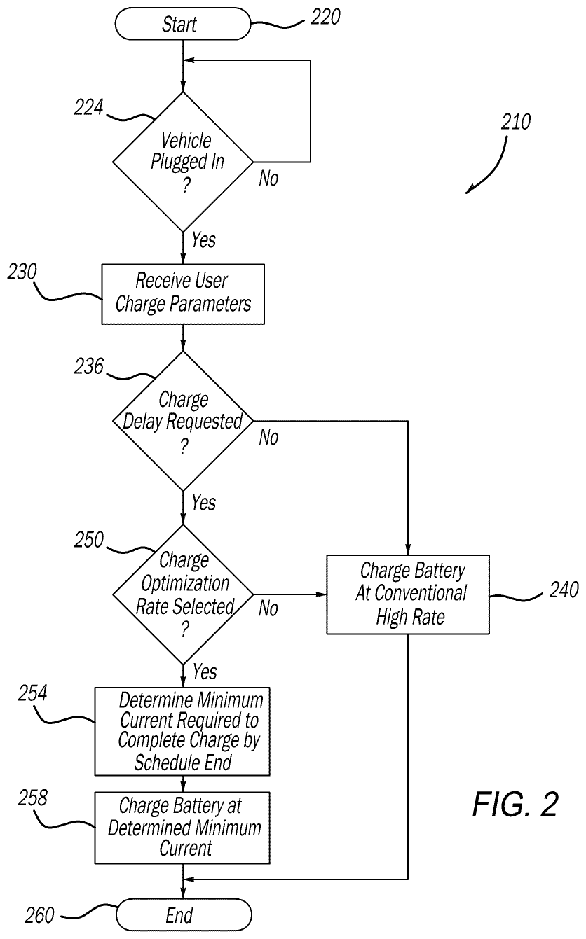

With additional reference now to FIG. 2, a control method 210 that implements an automated charging strategy using the automated charging system 144 of FIG. 1 according to one example of the present disclosure will be described. The method starts at 220. At 224 control determines whether the electrified vehicle 100 is plugged in to the external charging system 124. If not, control loops to 224. If control determines that the electrified vehicle 100 is plugged in, control receives user charge parameters at 230. In examples, user charge parameters can be received at the HMI 164. The charge parameters can include any parameter related to a charge event of the battery system 112 such as, but not limited to, a desired state of charge (e.g., such as to 80% of full charge), a charge start time (e.g., such as a delay in charge start time to begin during off-peak electricity rates related to the external charging system 124), and a charge end time (e.g., a time that the user wants to have charging completed to the desired state of charge).

At 236, control determines whether a charge delay has been requested from the charge parameters 230. If no delay in charge time has been requested at 236, control proceeds to charge the battery system 112 at a conventional high rate of charge at 240. If a charge delay has been requested at 236, control determines whether a charge optimization rate has been selected at 250. In examples, the charge optimization rate can be selected at the HMI 164. If the charge optimization rate has not been selected, control proceeds to charge the battery system 112 at a conventional high rate of charge at 240.

If the charge optimization rate has been selected at 250, control determines a minimum current required to complete the charge to the desired capacity by the desired schedule end time at 254. In examples, the controller 150 can base the minimum current on a number of known factors. In this regard, the controller 150 has preset statistics of the battery system 112, such as capacity. The controller 150 can further have preset statistics based on the charger supply amperage of the external charging system 124. In other examples, the controller 150 can determine the parameters of the external charging system 124 based on a prior charging event. The controller 150 can also be programmed (such as through the HMI 164) to have preset parameters of preferred windows of time that take advantage of “off-peak” electricity rates (such as, for example, 11 pm to 7 am).

An exemplary charging event that utilizes the optimization rate selected at 250 will now be described. The electrified vehicle 100 has a battery system 112 that includes a 65 kWh battery. The user has input charge parameters 230 including a desire to charge to 80% of capacity. The battery system 112 is currently at 20% charge. Such a charging event will require about 40 kWh of total energy. The external charging system 124 can supply 48 A (11.5 kW at 240 V). The utility rate based scheduled charge window is 8 hours (from 11pm to 7 am). The charge parameters received at 230 also include a desired charge end time of 7 am. The controller 150 determines a minimum current required to complete the charge by the scheduled end. At 258 control charges the battery system 112 at the determined minimum current. Control ends at 260.

In the example provided, the controller 159 determines that it will only take about 3.5 hours to complete a 40 kWh charge at 48 A. The controller 150 therefore reduces the charge current at 258 to 21 A and still complete the charge to the desired capacity in the window allotted. In examples, 21 A=40 kWh/(8 hr*240V). In this example, the charge current to the battery system 112 was reduced to 43% of the original rate, which will help improve the life of the battery system 112. It is appreciated that the control method 210 can determine different currents using other charge parameters within the scope of the present disclosure.

The instant control system and method allows the battery system 112 to reach the desired charge capacity by the desired charge end time while also reducing the charge rate (e.g., current supplied by the external charging system 124) thereby extending longevity of the battery system 112.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An automated charging system that charges a high voltage battery system of an electrified vehicle, the automated charging system comprising:
a human machine interface (HMI) that receives inputs from a user indicative of desired charge parameters related to the high voltage battery system;
a controller configured to:
receive the desired charge parameters including a desired state of charge of the high voltage battery at charge completion, and a desired charge end time;
determine whether a charge optimization rate has been selected;
determine a minimum current required to reach the desired state of charge by the desired charge end time based on the charge optimization rate being selected; and
charge the high voltage battery system at the minimum current required.

2. The automated charging system of claim 1, wherein the controller is further configured to:
determine whether the electrified vehicle is plugged into an external charging system.

3. The automated charging system of claim 1, wherein the controller is further configured to:
determine whether a delay of charge start time has been requested; and
charge the high voltage battery system at a conventional high rate based on the delay not being requested.

4. The automated charging system of claim 1, wherein the controller is further configured to:
receive the desired charge parameters including a charge start time.

5. The automated charging system of claim 1, wherein determining whether a charge optimization rate has been selected includes determining whether the charge optimization rate has been selected at the HMI.

6. The automated charging system of claim 1, wherein the controller is further configured to determine the minimum current based on a capacity of the high voltage battery system.

7. The automated charging system of claim 2, wherein the controller is further configured to determine the minimum current based on a capacity of the external charging system.

8. A method that implements an automated charging strategy using an automated charging system of an electrified vehicle, the method comprising:
receiving, at a controller, desired charge parameters including a desired state of charge of the high voltage battery at charge completion, and a desired charge end time;
determining, at the controller, whether a charge optimization rate has been selected;
determining, at the controller, a minimum current required to reach the desired state of charge by the desired charge end time based on the charge optimization rate being selected; and
charging the high voltage battery system at the minimum current required.

9. The method of claim 8, further comprising:
determining, at the controller, whether the electrified vehicle is plugged into an external charging system.

10. The method of claim 8, further comprising:
determining, at the controller, whether a delay of charge start time has been requested; and
charging the high voltage battery system at a conventional high rate based on the delay not being requested.

11. The method of claim 8, further comprising:
receiving, at the controller, the desired charge parameters including a charge start time.

12. The method of claim 8, wherein determining whether a charge optimization rate has been selected includes determining whether the charge optimization rate has been selected at the HMI.

13. The method of claim 8, further comprising:
determining, at the controller, the minimum current based on a capacity of the high voltage battery system.

14. The method of claim 9, further comprising:
determining, at the controller, the minimum current based on a capacity of the external charging system.
